(19) United States
(12) Patent Application Publication
(10) Pub. No.: US 2007/0200714 A1
(43) Pub. Date: Aug. 30, 2007

(54) Sound activated infant comfort device

(76) Inventors: Stephen M. Smith, Carlsbad, CA (US); Hubert Blackwell, Santa Clarita, CA (US)

Correspondence Address: Raymond M. Galasso;Galasso & Associates LP, P.O. Box 26503, Austin, TX, 78755-0503, US

(21) Appl. No.: 11/704,597

(22) Filed: Feb. 9, 2007

Related U.S. Application Data
(60) Provisional application No. 60/774,336, filed on Feb. 17, 2006.

(51) Int. Cl. G08B 23/00

(52) U.S. Cl. 340/573.1

(57) ABSTRACT

An apparatus configured to be releasably secured to a crib that functions to provide a plurality of stimuli in order to provide comfort to a distressed child disposed within the crib. The apparatus further includes a sound activated switch that is configured to monitor the area proximate the apparatus for a noise that exceeds a predetermined decibel level and subsequently activate the apparatus to provide audio stimulus to comfort the distressed child. A graphical display area further provides the infant with visual stimuli. The apparatus further includes a controller that regulates operation of the apparatus and a speaker to broadcast the audio stimulus.

### PRIORITY UNDER 35 U.S.C. 119(e) & 37 C.F.R 1.78

This nonprovisional application claims priority based upon the following prior United States provisional patent application entitled: Baby Comfort, Application No.: 60/774,336, file Feb. 17, 2006, in the names of Stephen M. Smith and Hubert Blackwell, which is hereby incorporated by reference for all purposes.

### FIELD OF THE INVENTION

The present invention relates to a comfort providing apparatus, more specifically but not by way of limitation, an apparatus for providing auditory and visual stimuli to an infant while within a crib to substantially relieve symptoms of discomfort experienced by the child such as but not limited to crying.

### BACKGROUND

Caring for an infant can be a very demanding task. Infants can become fretful or annoyed throughout the day due to discomfort brought on by various factors such as hunger, tiredness or anxiety. Typically during the daily childcare routine, a caregiver will utilize numerous different devices to sooth a fretful or anxious child. Devices such as mobiles and other toys are routinely placed adjacent to or in a child's crib in an effort to reduce the symptoms of a fretful or annoyed child.

During the infant stage, caretakers facilitate behavioral management and development of the child by utilizing many methods of stimulation for the infant. As is known to those skilled in the art, one issue that caretakers endure during caring for a child is that infants and small children usually do not like to be removed from their parent for any length of time. This situation can routinely cause an infant to experience great stress which usually results in the child displaying symptoms such as but not limited to crying. One problem with current devices used to sooth an infant is that while they have shown to provide auditory and visual stimuli to the infant, no current apparatus utilizes a combination of a pictorial representation of the parent and an audio recording of the parent to provide familiarity and comfort to the child.

Another issue with most common toys such as mobiles placed in the crib to sooth and or entertain the child is that they can not be activated by the sounds of distress from the child. Current devices are usually activated by the caregiver and will operate until de-activated by the caregiver.

Accordingly, there is a need for an apparatus that can provide familiar visual and auditory stimuli such as a picture and recording of the parent's voice that functions to interact with a distressed infant and activate upon detecting symptoms of distress.

### SUMMARY OF THE INVENTION

It is the object of the present invention to provide an apparatus that utilizes visual and auditory stimuli in response to detecting symptoms of a distressed child such as but not limited to crying.

Another object of the present invention is to provide an apparatus that utilizes auditory stimuli in response to detecting symptoms of a distressed child that is a recording of the voice of the parent of the child.

A further object of the present invention is to provide an apparatus that utilizes visual stimuli to sooth a distressed child that is a pictorial representation of the child's parent.

Yet another object of the present invention is to provide an apparatus that provides visual and auditory stimuli to an infant that is activated upon detecting sounds resembling those produced by a distressed child.

An additional object of the present invention is to reduce the separation anxiety between the infant and its parents by utilizing visual and audio stimuli that is activated subsequent to the detection of audible distress symptoms from the infant.

Another object of the present invention is to provide an apparatus that provides visual and auditory stimuli to sooth a distressed child that can be readily attached to a crib.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of a preferred embodiment of the present invention;

FIG. 2 is a top view of the present invention; and

FIG. 3 is a side view of the present invention.

### DETAILED DESCRIPTION

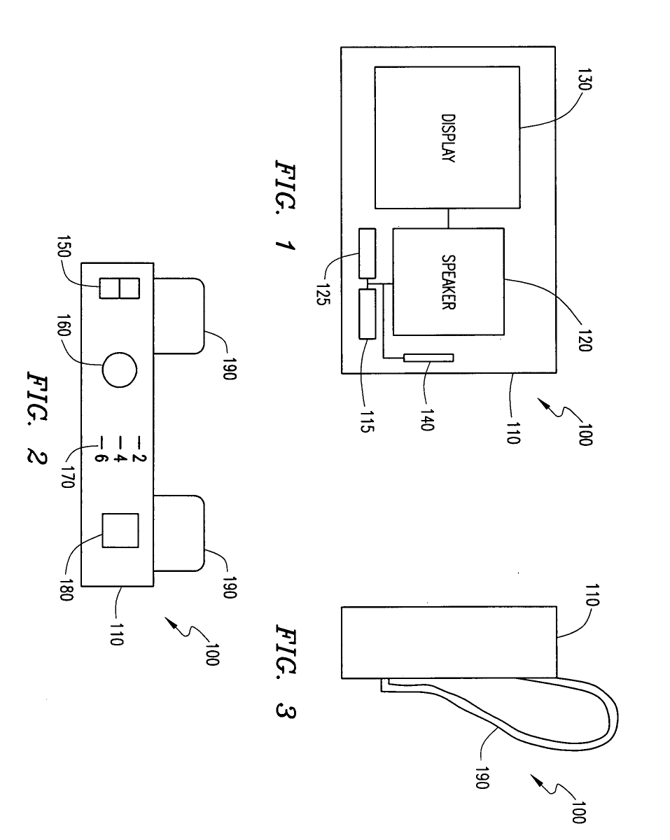

Referring now to the drawings, wherein various elements depicted therein are not necessarily drawn to scale and wherein like elements are designated with like reference numerals throughout the views and figures, and in particular FIGS. 1 through 4, there is illustrated a comfort apparatus 100 constructed according to the principles of the present invention.

Comfort apparatus 100 comprises a housing 110 which has incorporated therein a controller 115, a sound activated switch 125, a power source 140, speaker 120 and a display unit 130. The comfort apparatus 100 releasably secures to a infant crib and functions to generate a desired audio signal such as but not limited to a song or recording of a voice subsequent to detection of a noise such as but not limited to crying in an effort to sooth the upset infant without direct engagement from the infant's caretaker. The housing 110 is generally rectangular in shape and is manufactured from suitable durable materials such as but not limited to plastic. While no particular size is required for the housing 110, good results have been achieved with a housing 110 that is approximately nine inches in length and six inches in height and two inches in thickness. It is further contemplated within the scope of the present invention that the housing 110 could be manufactured in numerous different colors.

Although controller 115 and sound activated switch 125 are illustrated as block schematics, it is contemplated that controller 115 include circuit boards and memory and are configured such as to store, receive and manipulate sound files such as music or other recorded sounds. The controller 115 functions to control operations of the comfort apparatus 100 and is operably connected to the sound activated switch 125. The sound activated switch 125 functions to detect sound from the area proximate the comfort apparatus 100. Subsequent to detection of sound that exceeds a pre-determined level the sound activated switch 125 generates a signal which is delivered to the controller 115. Subsequent to receiving the signal from the sound activated switch 125 the controller 115 will transmit a signal to the power supply 140 thereby activating the comfort apparatus 100 from a standby mode to provide sufficient power to play a sound file stored within the memory of the controller 115. While no particular level of sound is required for the sound activated switch 125 to activate the comfort apparatus 100, it is contemplated within the scope of the present invention that the sound activated switch 125 transmit a signal to the controller 115 subsequent to detecting a sound that has a level that is consistent with that of a crying infant.

While it is desired that the comfort apparatus 100 be activated to play a desired sound utilizing the sound activated switch 125, those skilled in the art will recognize that the comfort apparatus 100 could utilize various types of switches such that comfort apparatus, for example, would operate in response to the detection of the proximity of the infant.

Power supply 140 is operably connected to the controller 115 and functions to supply the necessary voltage to operate the comfort apparatus 100. It is contemplated within the scope of the present invention that the power supply 140 could be manufactured from an alkaline battery, rechargeable battery or consist of a conventional power supply configured to be coupled with a power source such as a 120V power source.

Speaker 120 is disposed within the housing 110. The speaker 120 is manufactured as is known in the art and functions to play the audio data that is stored within the controller 115. A volume control 160 is operably connected to the speaker 120 which functions to allow a user to define the volume at which the audio data is played via the speaker 120. While only one speaker 120 is shown in the drawings submitted herewith, it is contemplated within the scope of the present invention that any number of speakers 120 could be utilized within the comfort apparatus 100.

Display unit 130 is positioned adjacent the speaker 120. The display unit 130 functions to allow a user to display a desired image to an infant proximate to the comfort apparatus 100. It is contemplated within the scope of the present invention that the display unit 100 could be a conventional display monitor that is configured to receive digital photographic images. It is further contemplated within the scope of the present invention that the display unit 130 could be configured to receive therein a conventional photograph or other material having a desired photographic image thereon such as but not limited to the parent of the adjacent infant. It is also contemplated within the scope of the present invention that the comfort apparatus 100 have a graphical display unit 130 that is configured to receive photographic data files from conventional memory devices utilized in digital cameras. Furthermore, it is contemplated within the scope of the present invention that the comfort apparatus 100 be configured for connectivity to a network or the internet and utilize the display unit 130 to display images received therefrom.

Referring in particular now to FIG. 2, comfort apparatus 100 includes a power switch 150 is operably coupled with the power supply 140 and the controller 115. The power switch 150 is manufactured from a conventional electrical switch and functions to provide a user interface to activate the comfort apparatus 100. In one position the power switch 150 electrically decouples the controller 115 from the power supply 140 thus rendering the comfort apparatus 100 inoperable. In a second position, the power switch 150 electrically couples the controller 115 and the power supply 140 thereby activating the controller 115. Subsequent to activation, the controller 115 will receive and process signals from the sound activated switch 125.

Comfort apparatus 100 also includes is a record switch 180 that functions to provide an interface for the user to record and store for subsequent reuse a desired sound such as a voice recording of a parent of an infant. The record switch 180 is manufactured from conventional electrical switches as is known in the art and is operably connected to the controller 115. Subsequent to depressing the record switch 180, the user will generate a desired sound such as a song through any desired method. The sound is recorded by conventional methods and is stored within the controller 115. While no particular length of sound is required, it is contemplated within the scope of the present invention that the comfort apparatus 100 be configured to receive and store sound data files that are approximately one minute in length. It addition to recording a user voice or sound, it is contemplated that comfort apparatus 100 could includes a data interface, such as a USB or other type of data interface, to allow a user to load onto the comfort apparatus pre-recorded sounds and/or songs in various formats, such as, but not limited to .wav and .mp3 data file formats. Those skilled in the art will recognize that the controller 115 could be configured to receive therein sound data files of numerous different sizes. Furthermore, it is contemplated within the scope of the present invention, that the controller 115 be configured to receive and store therein a plurality of sound data files.

Intermediate the power switch 150 and the record switch 180 is a message repeat switch 170. Message repeat switch 170 allows the user to establish how many times the stored message will play upon activation of the comfort apparatus 100.

As shown in FIGS. 2 and 3, an attachment mechanism 190 is secured by suitable methods to the housing 110. The attachment mechanism 190 is generally elongated and rectangular in shape and is manufactured from suitable durable materials. The attachment mechanism 190 functions to releasably secure the comfort apparatus 100 to an infant's crib or other desired structure in which an infant is disposed or proximate thereto. Those skilled in the art will recognize that numerous different types and amounts of attachment mechanisms 190 could be utilized to releasably secure the comfort apparatus 100 to a desired structure.

While it is illustrated in the drawings submitted herewith that the comfort apparatus 100 is activated with a power switch 150, it is further contemplated within the scope of the present invention that the comfort apparatus 100 be configured to be controlled with a standard remote control unit such as an RF or IR remote control.

It is further contemplated within the scope of the present invention that the power switch 150, repeat switch 170 and record switch 180 be configured such that they inhibit operation by an infants, such as by incorporating covers into housing 110 to covers these items.

Additionally, the comfort apparatus 100 could include therein a conventional video baby monitor that functions to allow a caretaker to monitor the condition of the infant from a remote location.

Those skilled in the art will also recognize that numerous different types of data files could be stored and utilized in the controller 115. More specifically but not by way of limitation, the controller 115 could be configured to generate a light sequence in order to illuminate a configuration of lights that could be superposed on the housing 110 of the comfort apparatus 100 in addition to and/or in conjunction with the playing of sound data files in order to comfort a distressed infant proximate thereto.

A description of the operation of the comfort apparatus 100 is as follows. In use, a user will releasably secure the comfort apparatus 100 to a desired structure such as an infant's crib. Using power switch 150 the power supply 140 which is electrically coupled to the controller 115 is activated. The user then utilizes the repeat switch 170 to the number of repetitions to be played. The record switch 180 is then used to record a sound data file to be stored within the controller 115 and subsequently played by the comfort apparatus 100. Subsequent to the recording of the sound data file, the comfort apparatus 100 utilizes the sound activated switch 125 to monitor the area proximate thereto for noise exceeding a predetermined decibel level.

Ensuing detection of a noise exceeding the predetermined decibel level, the sound activated switch 125 which is electrically coupled to the controller 115 transmits a signal to the controller 115 to play the selected sound data file stored within the controller 115 that has been selected by the user with the data identification switch 170. The comfort apparatus 100 plays the sound file in its entirety through the speaker 120 and repeats it pursuant to the position of repeat switch 170.

Subsequent to the completion of playing the data file, the sound activated switch 125 continues to monitor the area proximate the comfort apparatus 100 for noise exceeding the predetermined decibel level in order to transmit an additional signal to the controller 115 to play the sound file.

The graphical display unit 130 is utilized by the user to display a desired photographic or other image to the adjacent infant. The user can deactivate the comfort apparatus 100 using power switch 150.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus configured to provide comfort for a user comprising:
a controller, said controller being operable to record, receive, store and utilize data files for producing at least one stimuli, and
a switch, said switch being operably connected to said controller, said switch operable to detect sound and further configured to activate the controller in response to the detection of sound exceeding a first level.

2. The apparatus as recited in claim 1, wherein said controller is configured to provide at least one of an audio stimuli and a visual stimuli

3. The apparatus as recited in claim 2, and further including a speaker connected to said controller, said speaker for generating an audio stimuli.

4. The apparatus as recited in claim 3, and further including a graphical display unit connected to said controller, said graphical display unit configured to provide visual stimuli to the user.

5. The apparatus as recited in claim 4, and further including an attachment mechanism for releasably attaching the apparatus to a structure.

6. The apparatus as recited in claim 5, and repeat switch operable with said controller to repeat the generation of said at least one of an audio stimuli and a visual stimuli tin response to said switch detecting the sound.

7. An apparatus configured to comfort a child comprising:
a detection mechanism, said detection mechanism configured to monitor the area proximate the apparatus for sound, said detection mechanism being further configured to transmit a signal to activate the apparatus in response to the sound; and
a controller, said controller being operably connected to said detection mechanism, said controller being configured to record, store and play data in order to provide at least one stimuli in response to a signal from said detection mechanism.

8. The apparatus as recited in claim 7, wherein said detection mechanism is further configured to transmit a signal to said controller subsequent to detecting a noise that exceeds a predetermined level.

9. The apparatus as recited in claim 8, and further including a recording interface, said recording interface being operably connected to said controller, said recording interface for facilitating the recording of sound by a user.

10. The apparatus as recited in claim 9, and further including a selection mechanism, said selection mechanism being configured to facilitate a user identifying a recording stored within said controller for the apparatus to play subsequent to activation by said detection mechanism.

11. The apparatus as recited in claim 10, wherein at least one of said at least one stimuli provided by said controller is audio stimuli.

12. The apparatus as recited in claim 11, and further including a graphical display unit, said graphical display unit for providing visual stimulus to a distressed child.

13. The apparatus as recited in claim 12, wherein the sound activating the apparatus is that of a crying sound of a child.

14. A child comforting device, comprising:
a detection mechanism, said detection mechanism configured to monitor the area adjacent to the apparatus for sound, said detection mechanism being operable to activate the apparatus in response to detecting a sound; and
a controller, said controller being operably connected to said detection mechanism, said controller being configured to record, receive, store and play data in order to provide a first and a second stimulus to a distressed child.

15. The child comforting device as recited in claim 14, wherein the first stimuli is sound.

16. The child comforting device as recited in claim 15, wherein said detection mechanism is further configured to activate said controller in response to detection of a sound exceeding a predetermined decibel level.

17. The child comforting device as recited in claim 16, wherein said controller is further configured to receive via a user interface a recording of a desired sound to be stored and subsequently played ensuing activation of said controller by said detection mechanism.

18. The child comforting device as recited in claim 17, and further including a selection switch, said selection switch configured to provide a user interface for facilitating the selection of a stored audio data file from said controller to be played in response to said detection mechanism activating the apparatus in response to detecting a sound exceeding the predetermined decibel level.

19. The child comforting device as recited in claim 18, and further including a graphical display unit, said graphical display unit for providing said second stimulus to the distressed child.

20. The child comforting device as recited in claim 19, wherein the apparatus is approximately nine inches in length, six inches in height and two inches in width.
